(19) United States
(12) Patent Application Publication
(10) Pub. No.: US 2002/0129683 A1
(43) Pub. Date: Sep. 19, 2002

(54) Machine tool system

(76) Inventor: Martin Peter Ollis, Warwickshire (GB)

Correspondence Address: Wendi L. Weinstein, BURNS, DOANE, SWECKER & MATHIS, L.L.P., P.O. Box 1404, Alexandria, VA, 22313-1404, US

(21) Appl. No.: 09/804,153

(22) Filed: Mar. 13, 2001

(30) Foreign Application Priority Data
Mar. 13, 2001 (GB) 0006041.8

(51) Int. Cl. B23B 9/02

(52) U.S. Cl. 82/110; 82/119; 82/120

(57) ABSTRACT

A machine tool system with a primary motor and a first slave motor, each motor operably being adapted to drive a separate sub-system within the machine tool system, wherein a control system operably controls the speed of the first slave motor at a predetermined speed relative to the speed of the primary motor.

### TECHNICAL FIELD

This invention relates to machine tool systems, and in particular to multi-spindle automatic bar machines.

### BACKGROUND OF THE INVENTION

Conventional multi-spindle automatic bar machines have complex gearing mechanisms that allow various parts of the machine to rotate at pre-selected speeds, power being provided by a single standard electric motor.

FIG. 1 shows in simplified form the gear layout for a five spindle automatic bar machine with a conventional single motor drive. The machine has a head HI that rotates stepwise about axis A-A′ and has an inner face F1 with five equidistantly spaced work spindles P1 each of which is linked by a shaft and gear wheel (not shown) to a ring gear G1 having teeth on both the inside and outside of the ring. The outer teeth of ring gear G1 are driven by a conventional AC electric motor M via shaft S1 and gear wheels G2 and G3. Thus, as the ring gear G1 rotates about axis A-A′ all five work spindles P1 also rotate about axes B-B′. Head H1 revolves stepwise about axis A-A′ as a result of the rotation of cross slide cams CA1.

Adjacent to and spaced some distance apart from inner face F1 of revolving head H1 is a stationary head H2. This head has five equidistantly spaced tool spindles P2 arranged on the same pitch circle as the work spindles P1. Thus, during the machining steps the tool spindles P2 and the work spindles P1 are aligned so that axes B-B′ are coaxial with the center lines C-C′ of tool spindles P2. During the so called “indexing phase” head H1 rotates (in this case by 72 degrees) so that each work spindle is aligned with a new tool spindle.

Four of the five tool spindles P2 are stationary but one is usually rotatably mounted for threading and is connected via shaft S2, gears G4, G5, G6, shaft S3, clutch C1 and shaft S4 to gear wheel G3. The rotational speed of this spindle can be varied by changing the gearing ratio, for example the number of teeth in wheels G5 and G6 or by using a gearbox and extra clutch (not shown). Tools held in spindles P2 are moved axially (in direction C-C′) by the action of the rotating tool spindle cam assembly CA2 on cam followers and linkage arms (not shown). Thus as cam assembly CA2 rotates about its vertical axis the five individual cams each move their associated tool spindle in an axial direction either towards or away from the rotating head according to the contour of each individual cam. Cam assembly CA2 is driven by shaft S5 via worm gear G7, shaft S6 and clutch C2, gear wheels G8 and G9 to shaft S1.

Tools associated with each work spindle (for example a rod cutter) are controlled by cross slide cam assembly CA1 each cam of which act on a cam follower and linkage mechanism (not shown). Thus as cam assembly CA1 rotates about its horizontal axis individual cams each move associated tools, relative to the rotating work spindles P1, according to the contour of each individual cam. Cam assembly CA1 is driven via worm gear G10 by shaft S7, bevel gears G11, G12 shaft S8, gears G13, G14 and clutch C3 to shaft S6.

Thus, when the machine is operating motor M drives cams CA1 and CA2, revolving head H1, work spindles P1 and tool spindle P2.

While such systems work reliably they tend to be noisy and require replacement of some gear wheels when tooling for another job. The clutches require constant adjustment if optimal machine output is to be maintained, in practice, this normally proves to be impractical. Tooling up for another job generally requires removal and replacement of selected gears in order to obtain the gear ratios appropriate for the manufacture of the new part.

### SUMMARY OF THE INVENTION

It is an object of the present invention to provide an improved machine tool system.

In one aspect the invention provides a machine tool system with a primary motor and a first slave motor each motor operably being adapted to drive a separate sub-system within the machine wherein a control system is used to control the speed of the first slave motor at a predetermined speed relative to, and/or at a fixed ratio of, the speed of the primary motor.

Preferably, the control system is computerized such as a computer numerically controlled (CNC) system and/or the motors are electronically driveable such as servo motors like 12V DC servo motors.

The machine tool system may further comprise a second slave motor wherein the control system is used to control the speed of the second slave motor at a predetermined speed relative to one of the first slave motor and the primary motor.

A first sub-system may comprise a plurality of rotating work spindles. The rotating work spindles may be mounted on a rotating head. The rotating head may be driven by the primary motor. The first sub-system may be driven by a slave motor,

A second sub-system may comprise a plurality of cams mounted on at least one shaft.

A third sub-system may comprise a plurality of tool spindles mounted on a stationary head.

A fourth sub-system may comprise a plurality of cams mounted on at least one shaft wherein rotation of the cams produces axial movement of the tool spindles. The second and fourth subsystems may be driven by the primary motor.

A fifth sub-system may comprise means of driving at least one rotatably mounted tool spindle. The fifth sub-system may be driven by a slave motor.

Preferably, the machine tool system comprises means of detecting the rotational angle of the primary motor and feeding this data to the controller.

In another aspect the invention provides a control system for a machine tool with a primary motor and at least one slave motor, each motor operably being adapted to drive a separate sub-system within the machine tool system wherein a control system is used to control the speed of the at least one slave motor at a predetermined speed relative to the speed of the primary motor. Beneficially such control system can be retrofittable to a conventional machine tool such as shown in FIG. 1, thereby removing the need for much of the complex drive shaft and gear arrangement described earlier.

Preferably, a detector is used to indicate the angular position of the primary motor drive shaft.

Preferably, the control system is computerized such as a CNC system and the motors are electronically driveable such as servo motors.

Preferably, the degree of axial rotation of the primary motor over a fixed time period is used to determine the required axial rotation of a slave motor over the same time period. The control system may comprise a first and a second slave motor wherein the degree of axial rotation of the first slave motor over a fixed time period is used to determine the required axial rotation of the second slave motor over the same fixed time period. Preferably, the fixed time period is between 0.01 and 0.001 seconds, and more preferably between 0.002 and 0.006 seconds.

The motors may rotate in both a clockwise and anticlockwise direction. The primary motor may be driven at varying speeds at different stages of the machine cycle. Preferably, the primary motor is driven at a first constant speed during one stage of the machining cycle and a second constant speed during a further stage of the cycle.

Preferably, the primary motor can be rotated by fractions of a revolution using a hand operated controller interfacing with the control unit. Preferably, the ratio of the speed of the slave motor, or motors or primary motor is set by the operator using a control panel.

Preferably, settings appropriate to a particular job can be input via operator panel connected to the control unit and set values can be displayed on a screen controlled by the control unit.

Preferably, each motor unit has integral means of detecting the angular position of the motor shaft.

### BRIEF DESCRIPTION OF THE DRAWINGS

An embodiment of the invention relating to a five spindle automatic bar machine will now be described by way of example only, with reference to the following schematic drawings in which:

FIG. 1 is a schematic block diagram of a machine tool system according to the prior art;

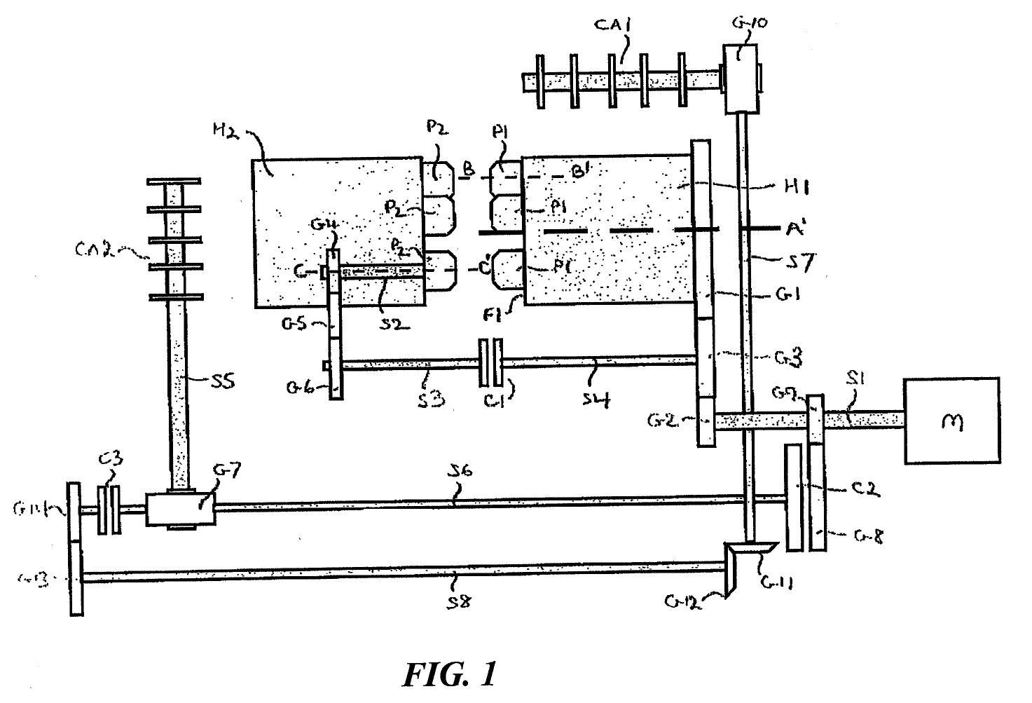

FIG. 2 shows the general arrangement of the motors, gears, spindles and cams for a system according to the invention;

FIG. 3 shows selected features of the front face of the work spindle, shown in FIG. 2;

FIG. 4 depicts the control arrangement for a system according to the invention employing three servo motors;

FIG. 5 is a logic flow diagram for an electronic gearbox according to the invention;

FIG. 6 is a logic flow diagram for a so called root program, and according to the invention;

FIG. 7 is a logic flow diagram for live data calculations conducted according to the invention in use.

### DETAILED DESCRIPTION OF THE INVENTION

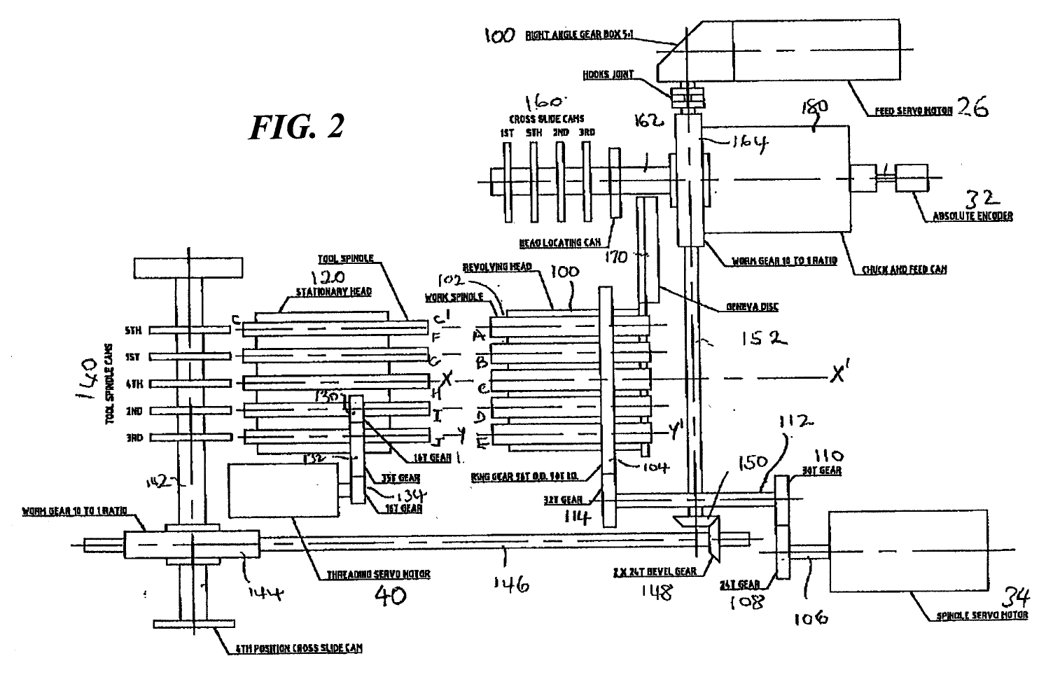

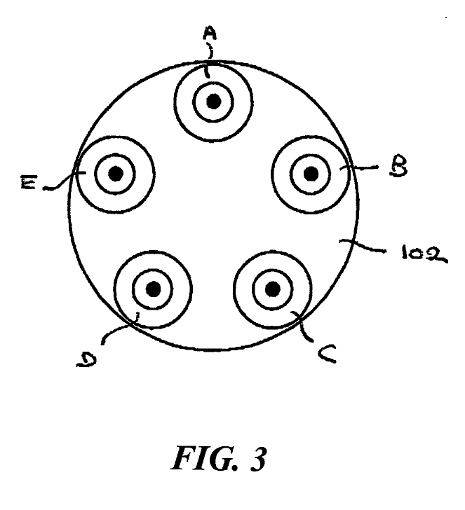

Referring to FIG. 2, the machine tool system has a head 100 that is mounted so that it may rotate step-wise about axis X to X′ and has an inner face 102 with five work spindles A to E the centers of which lie on a circle, the spacing between adjacent spindles being constant (see FIG. 3). Each spindle A to E is linked by a shaft and a gear wheel (not shown) to the inner teeth of a ring gear 104 having teeth on both the inside and outside of the ring. The outer teeth of the ring gear 104 are driven by spindle servo motor 34 via shaft 106, gears 108, 110, shaft 112 and gear 114. Thus, as ring gear 104 rotates about axis X to X′ all five work spindles A to E rotate about respective longitudinal axes, such as Y to Y′ in the case of spindle E.

Adjacent to and spaced some distance apart from inner face 102 of revolving head 100 is a stationary head 120. This head has five equidistantly spaced tool spindles F to J arranged on the same pitch circle as the work spindles A to E. Thus, during the machining steps the spindles F to J and the work spindles A to E are aligned so that axis Y to Y′ are coaxial with the center lines of C to C′ of the tool spindles F to J. During the so called indexing phases head 100 rotates (in this case by 72 degrees) so that each work spindle is aligned with a new tool spindle.

Four of the five tool spindles are stationary but one spindle I is rotatably mounted and connected via gears 130 and 132 (idle gear) and 134 to threading servo motor 40. Tools held in spindles F to J are moved axially in the direction Y to Y by the action of the rotating tool spindle cam assembly 140 on cam followers and the linkage arms (not shown). Thus, as cam 140 rotates about its vertical axis, five individual cam each move their associated tool spindles F to J either towards or away from the rotating head according to the contour of each individual cam. Cam assembly 140 is driven by feed servo motor 26 via shaft 142, worm gear 144, shaft 146, bevelled gears 148 and 150 and shaft 152.

Tools associated with each work spindle (for example a rod cutter) are controlled by cross slide cam assembly 160 comprising individual cams each with a cam follower and linkage mechanism (not shown). Thus, as cam assembly 160 rotates about its horizontal axis each cam moves its associated tool according to the contour of the cam. Cam assembly 160 is driven by servo feed motor 26 via a shaft 162 and worm gear 164 and shaft 152. Head 100 is rotated step-wise about axis X to X′ being driven by the feed servo motor 26 via Geneva gear 170, shaft 162, work gear 164 and shaft 152.

Thus, when the system is operating the primary (feed servo) motor 26 drives cam assemblies 140, 160 and rotates head 100, the spindle servo motor 34 rotates work spindles A to E, and the threading motor 40 rotates tool spindle I.

In use rods of raw material (not shown) are fed step-wise in the direction X to X′ from a cradle (not shown) that also rotates about X to X′, to each work spindle. Each work spindle A to E has a chuck (not shown) that is opened and closed by hydraulic means, the hydraulic pressure being generated by the action of cam followers that engage cams located on shaft 162 within the chuck and feed cam assembly 180. A rod feeding mechanism that advances the rods through revolving head 100 is also operated by similar hydraulic means to the chuck and feed assembly 180.

An absolute encoder 32 detects the angular position of the shaft 162. This generates data used by the machine tool control system (see later). The absolute encoder allows the machine to be switched off and back on without position loss.

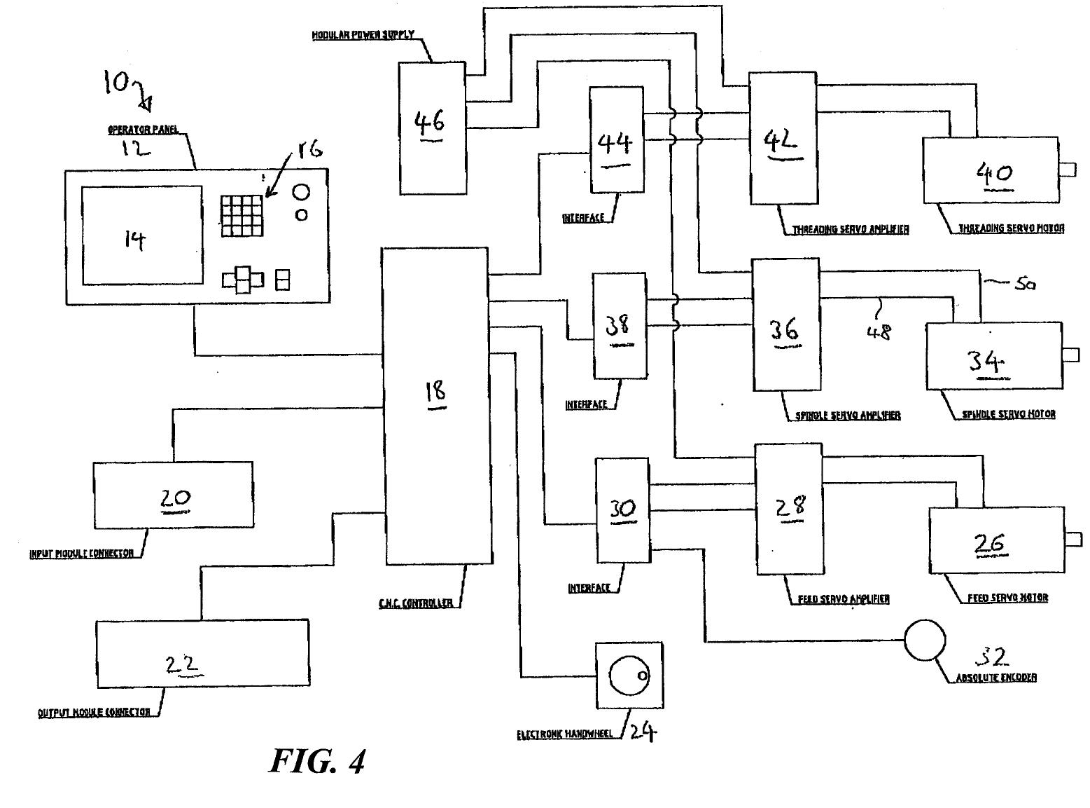

FIG. 4 shows the main components of a control system 10 according to the invention which comprises an operator panel 12 having a display screen 14 and operator inputs 16 such as a keypad. The operator panel 12 is connected to an electronic controller such as a microprocessor or CNC controller 18 which can be electronically interfaced by a user using input module connector 20 and/or output module connector 22.

There are three servo motors; feed servo motor 26, spindle servo motor 34, and threading servo motor 40. Each of these servo motors is connected to a CNC controller 18 via a respective servo amplifier and interface board, for example feed servo motor 26 is connected by a feed servo amplifier 28 and interface board 30 to the CNC controller 18. Each servo amplifier is powered by low voltage modular power supply unit 46. Power unit 46 can be a 12VDC unit for example. Absolute encoder 32 is connected to the CNC controller 18 via interface board 30.

Each servo motor has an integral resolver unit that detects the angular position of its drive shaft and two sets of connections to the associated servo amplifier. For example, spindle servo motor 34 is connected to spindle servo amplifier 36 by power cable 48 and also by resolver cable 50. The resolver unit and cable 50 allow the CNC controller to verify that the servo motor is operating correctly and that it has moved through a specified angular distance.

An electronic hand wheel 24 connected to CNC controller 18 allows the operator to rotate the primary servo motor 26 by fractions of a revolution in order to set-up the machine.

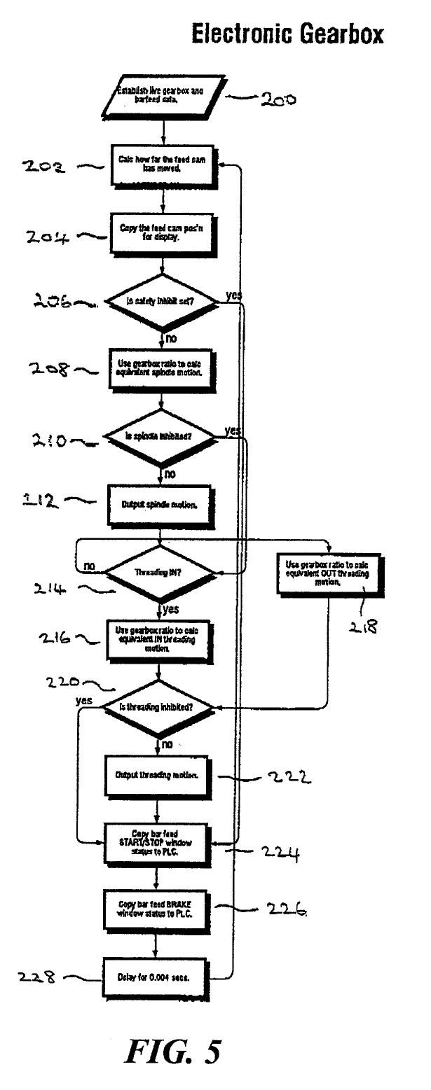

Referring to FIGS. 5 to 7 showing the overall control logic for the system. FIG. 5 shows the logic flow diagram for the electronic gearbox. The main function of this part of the control system is firstly to maintain the speed of the spindle servo motor 34 at a fixed ratio to that of the feed servo motor 26, and secondly to maintain the speed of the threading servo motor 40 at a fixed ratio to the spindle servo motor 34.

Live data calculations (see latter) are used to establish live gearbox and bar feed data [step 200]. Thus, in use a signal from the absolute encoder 32 is used to calculate how far (angularly) the shaft 162 and cam assemblies 160, 180 have moved as indicated at step 202. This data is then displayed on the operator panel screen 14 [step 204]. Then following a first safety check [step 206] the gearbox ratio data (established during the live data calculation phase) is used to calculate the required spindle servo motor 34 angular movement step 208. Providing spindle movement is allowed [step 210], the output (angular) spindle motion [step 212] is used by the CNC controller 18 to control spindle servo motor 34 via spindle servo amplifier 36 and interface board 38.

The controller then decides whether the moving tool spindle I is at the threading in stage or threading out stage [step 214]. If it is threading in, it uses gearbox data to calculate the required (inward) angular movement [step 216] of the threading servo motor 40. If it is threading out, it uses the gearbox data to calculate the required angle of movement (in the opposite direction) [step 218] of the threading servo motor 40. Providing motion of the threading spindle is allowed step 220 an output threading motion signal [step 222] is generated by the CNC 18 and used to control the threading servo motor 40 by a threading servo amplifier 42 and interface board 44. Data is then copied to the CNC 18 at steps 224 and 226 prior to a delay step of typically 0.004 seconds [step 228] and then returning to step 202. Thus, the sequence of steps 202 to 228 is repeated every 0.004 seconds. Motion of the tool spindle I is not allowed during the indexing phase (i.e, during movement of head 100) and motion of the work spindles may also not be allowed during this phase.

The electronic gearbox allows the complex shaft and gearing system of conventional machines to be replaced by a much simpler and quieter arrangement. The electronic nature of the gearbox allows an infinite number of ratios to be selected; in contrast to the relatively limited set of values obtainable from conventional machines, and the inconvenience of physically changing gear ratios in such machines.

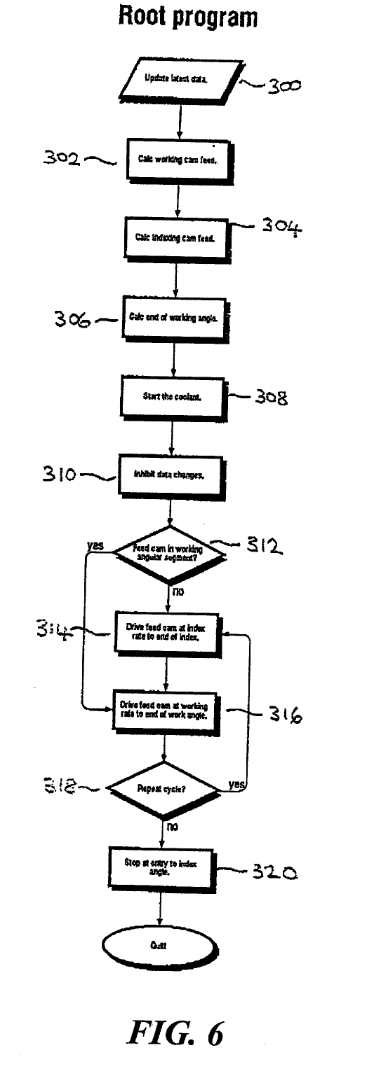

A root program, represented schematically in FIG. 6, controls the (primary) feed servo motor 26. The main function of this part of the control system is to drive servo motor 26 at a set indexed rate during the index phase and at a set working rate during the working phase. Thus, user input data [step 300] is used calculate the working rate [step 302] and index rate [step 304] for the primary servo motor 26 and also the angular range corresponding to the working phase [step 306]. Coolant is then started [step 308] and further data changes inhibited [step 310]. The absolute encoder 32 is then used to determine whether the feed and slide cams 160 and 180 are in the working angular segment [step 312]. If they are, the primary servo motor 26 is driven at the working rate to the end of the work angle [step 316]; if they are not, the primary servo motor 26 is driven at the index rate to the end of the index angle [step 314]. At the end of the working phase, providing a repeat cycle is called for step 318, the controller returns to the index phase step 314 and thus continually cycles between the index phase [step 314] and the working phase [step 316]. If a repeat cycle is not allowed the primary servo motor 26 stops at the entry to the index angle [step 320].

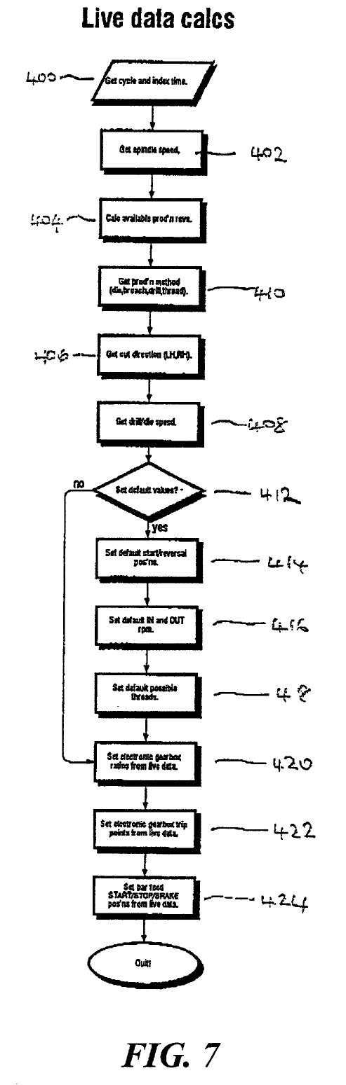

Live data calculations are performed by the CNC during a set-up period prior to production as indicated schematically in FIG. 7. Certain parameters are set by the operator, notably:

Cycle and index time [step 400]

Spindle speed [step 402]

Production method (die, broach,drill or thread) [step 404)

Cut direction (LH or RH) [step 406]

Drill/die speed [step 408]

From the cycle time [step 400] and spindle speed [step 402] the controller calculates the available production revolutions [step 410]. The operator can either select the current default settings for start/reversal position, in and out revolutions per minute, and possible threads [step 412] or can update these data [steps 414, 416, 418]. The input data are then used to calculate gearbox ratios [step 420] and to set up the gearbox trip points [step 422]. Finally, the operator sets the bar feed data [step 424].

The system allows increased productivity to be achieved firstly, through reduced tool set-up time and secondly because the production speed can in general be increased. The reduced set-up time results from eliminating the need to change gear trains and the increased productivity results from a generally faster rotating head speed made possible by the elimination of clutch members and the ability to control the primary motor at any desired speed during different parts of the production cycle, the speed of this motor being infinitely variable.

I claim:

1. A machine tool system with a primary motor and a first slave motor, each motor operably being adapted to drive a separate sub-system within the machine tool system, wherein a control system operably controls the speed of the first slave motor at a predetermined speed relative to the speed of the primary motor.

2. A machine tool system with a primary motor and a first slave motor, each motor operably being adapted to drive a separate sub-system within the machine tool system, wherein a control system operably controls the speed of the first slave motor at a fixed ratio of the speed of the primary motor.

3. A machine tool system according to claim 1 wherein the control system is computer controlled such as a computer numerically controlled system.

4. A machine tool system according to claim 1 wherein the motors are electronically driveable such as servo motors.

5. A machine tool system according to claim 1 further comprising a second slave motor wherein the control system operably controls the speed of the second slave motor at a predetermined speed relative to one of the first slave motor and the primary motor.

6. A machine tool system according to claim 1 with a first sub-system comprising a plurality of rotating work spindles.

7. A machine tool system according to claim 6 wherein the work spindles are mounted on a rotating head.

8. A machine tool system according to claim 7 wherein the rotating head is driven by the primary motor.

9. A machine tool system according to claim 1 with a second subsystem comprising a plurality of cams mounted on at least one shaft.

10. A machine tool system according to claim 1 with a third subsystem comprising a plurality of tool spindles mounted on a stationary head.

11. A machine tool system according to claim 1 with a fourth subsystem comprising a plurality of cams mounted on at least one shaft wherein rotation of the cams produces axial movement of tool spindles.

12. A machine tool system according to claim 1 with a fifth sub-system comprising means of rotatably driving at least one rotatably mounted tool spindle.

13. A machine tool system according to claim 1 comprising means of detecting the rotational angle of the primary motor and feeding this data to the controller.

14. A machine tool system according to claim 6 wherein the first subsystem is driven by a slave motor.

15. A machine tool system according to claim 1 with a second subsystem comprising a plurality of cams mounted on at least one shaft, and a fourth sub-system comprising a plurality of cams mounted on at least one shaft wherein rotation of the cams produces axial movement of tool spindles, and the second and forth sub-systems are driven by the primary motor.

16. A machine tool system according to claims 12 wherein the fifth sub-system are driven by a slave motor.

17. A control system for a machine tool system with a primary motor and a first slave motor, each motor operably being adapted to drive a separate subsystem within the machine tool system wherein the control system operably controls the speed of the first slave motor at one of a predetermined speed of or, a fixed ratio to the speed of the primary motor.

18. A control system for a machine tool system according to claim 17 wherein a detector is used to indicate the angular position of the primary motor drive shaft.

19. A control system for a machine tool system according to claim 17 wherein the control system is computer controlled such as a computer numerically controlled system.

20. A control system for a machine tool system according to claim 17 wherein one or more of the motors are electronically driveable such as servo motors.

21. A control system according to claim 17 wherein the degree of axial rotation of the primary motor over a fixed time period is usable to determine the required axial rotation of a slave motor over the same fixed time period.

22. A control system for a machine tool system according to claim 17 wherein the degree of axial rotation of the first slave motor over a fixed time period is used to determine the required axial rotation of the second slave motor over the same fixed time period.

23. A control system for a machine tool system according to claim 21 wherein the fixed time period is between 0.01 and 0.001 seconds and preferably between 0.002 and 0.006 seconds.

24. A control system for a machine tool system according to claim 17 wherein the second slave motor may rotate in both a clockwise and anti-clockwise direction.

25. A control system for a machine tool system according to claim 17 wherein the primary motor is driveable at varying speed at different stages of the machine cycle.

26. A control system for a machine tool system according to claim 17 wherein the primary motor is driveable at a first constant speed during one stage of the machine cycle and a second constant speed during a further stage of the cycle.

27. A control system for a machine tool system according to claim 17 wherein the primary motor is rotatable in stepwise increments by means of a user controlled interface such as a hand operated control.

28. A control system for a machine tool system according to claim 17 wherein the settings appropriate to a particular machining job are operably input via an operator panel connected to the control unit and the settings are operably displayed on a screen controlled by the control unit.

29. A control system for a machine tool system according to claim 17 wherein the control unit has integral means of detecting the angular position of a motor shaft associated with each motor.

30. A control system for a machine tool system according to claim 17 wherein the ratio of the speed of the slave motor or motors to the primary motor is set by the operator using a control panel.

31. A motor drive system for a machine tool system comprising a primary motor and a first slave motor, each motor operably being adapted to drive a separate sub-system within the machine tool system, wherein a control system operably controls the speed of the first slave motor at a predetermined speed relative to the speed of the primary motor.

32. A motor drive system for a machine tool system comprising a primary motor and a first slave motor, each motor operably being adapted to drive a separate sub-system within the machine tool system, wherein a control system operably controls, the speed of the first slave motor at a fixed ratio of the speed of the primary motor.
